(19) United States
(12) Patent Application Publication
(10) Pub. No.: US 2005/0064115 A1
(43) Pub. Date: Mar. 24, 2005

(54) Ink jet recording medium

(75) Inventors: Takayuki Suzuki, Tokyo (JP); Kiyoshi Endo, Kanagawa (JP); Tomohiko Sakai, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Holdings, Inc., Tokyo (JP)

(21) Appl. No.: 10/939,776

(22) Filed: Sep. 13, 2004

(30) Foreign Application Priority Data
Sep. 19, 2003 (JP) JP2003-327483

(51) Int. Cl. B41M 5/00

(52) U.S. Cl. 428/32.34

(57) ABSTRACT

An ink jet recording medium comprising a support and an ink absorptive layer provided thereon, the ink absorptive layer containing silica fine particles, wherein an absorption coefficient of the ink absorptive layer measured by dynamic scanning liquid absorption meter is from 1.0 to 5.0 ml/[m²·(msec)^{1/2}].

### FIELD OF THE INVENTION

The present invention relates to an ink jet recording medium, particularly to an ink jet recording medium which exhibit excellent ink absorbability as well as excellent image quality, high resolution and a superior coloring property.

### BACKGROUND OF THE INVENTION

Ink jet recording performs recording of images and letters by flying ink droplets based on various operation principles to be adhered onto a recording sheet such as paper, and has advantages of relatively high speed, low noise and easy multicolor formation.

In conventional recording methods, improvements from the both view points of ink and equipment have been made with respect to nozzle clogging and maintenance which had been problems conventionally, and an ink jet recording method has been rapidly prevailing in the fields of such as various printers, facsimiles and computer terminals.

As a recording medium utilized in this ink jet recording method, required are such that density of printed dots is high, tone is bright and vivid, ink absorption is rapid and ink does not flow out or bleed when printed dots are accumulated, the lateral diffusion of printed dots is not inadequately large as well as the circumference is smooth and not dimmed.

Heretofore, many techniques have been proposed to solve these problems. Many examples are known, for example, such as a recording sheet in which a low sized raw paper is wetted with paint for surface processing as described in JP-A No. 52-53012 (hereinafter, JP-A refers to Japanese Patent Publication Open to Public Inspection), a recording sheet in which the surface of the support is provided with an ink-absorptive coating layer as described in JP-A No. 55-5830, a recording sheet in which a non-gluey silica powder is contained in the covering layer as described in JP-A No. 56-157, a recording sheet in which an inorganic pigment and an organic pigment are incorporated in combination as described in JP-A No. 57-107878, a recording sheet having two void distribution peaks as described in JP-A No. 58-110287, a recording sheet comprising two porous layers of upper and under as described in JP-A No. 62-111782, a recording sheet which is provided with irregular-shaped cracks as described in such as JP-A Nos. 59-68292, 59-123696 and 60-18383, a recording sheet which is provided with a micro-powder layer as described in such as JP-A Nos. 61-135786, 61-148092 and 62-149475, a recording sheet which contains a pigment or fine particle silica having specific physical properties as described in such as JP-A Nos. 63-252779, 1-108083, 2-136279, 3-65376 and 3-27976, a recording sheet which contains fine particle silica such as colloidal silica as described in such as JP-A Nos. 57-14091, 60-219083, 60-210984, 61-20797, 61-188183, 5-278324, 6-92011, 6-183134, 7-137431 and 7-276789, and a recording sheet which contains alumina hydride fine particles as described in such as JP-A Nos. 2-276671, 3-67684, 3-215082, 3-251488, 4-67986, 4-263983 and 5-16517.

Even in the methods proposed above, there is a problem of deterioration of image quality due to insufficient ink absorbability. A method as disclosed in such as JP-A Nos. 52-9074, 58-72495 and 55-51583, in which an ink receiving layer having a thickness more than a predetermined layer thickness, comprising a pigment such as synthetic silica provided with a large specific surface area, is formed primarily, can assure a high ink absorbability, however, there is a problem that only an image having a lower dotted density and lacking visibility can be obtained. In another method to improve the surface wettability as described in such as JP-A No. 63-39373, a certain level of ink absorbability is obtained in the case of small ink dotting amount due to a lower resolution, however, while in the case of large ink dotting amount, there caused a problem that obtained can be only an image lacking sharpness because of basically insufficient ink absorbability resulting in ink flooding to generate bleeding of the image or enlarged dots.

Particularly, in recent years, because of increasing demand for high speed printing, dotting speed of ink droplets has been improved and ink dotting has come to be performed in shorter time intervals, owing to a progress of techniques of an ink jet recording method. To correspond these techniques, ink jet recording sheet is also required to have an ability of absorbing and fixing the dotted ink in a shorter time duration, and, for example, there was proposed to restrict the amount of water transferred onto the whole sheet in a time duration of around 0.1 second as disclosed in such as JP-A Nos. 2-76774 and 4-49086, however, the objective described above cannot necessarily be satisfied even with a recording sheets provided with these proposed physical properties because of faster printing techniques have been realized, which results in suggesting that not only a transferring amount but also physical properties of paper including absorption rate are determining factors for exhibition of a desired ink absorbability.

Recently, a recording medium, a transferring amount of water and an absorption coefficient of which are defined, has been also disclosed such as in JP-A No. 2001-130131, which has improved the absorbability, but, not solved the aforesaid problems of such as image quality.

### SUMMARY OF THE INVENTION

An objective of this invention is to provide an ink jet recording medium which exhibit excellent ink absorbability, high speed ink jet printing compatibility, excellent image quality, high resolution as well as a superior coloring property, when printing is performed by an ink jet printer.

The above objective of this invention can be achieved by the following constitutions.

Thus, in one aspect this invention is directed to an ink jet recording medium comprising a support having thereon at least one ink absorptive layer, containing silica fine particles comprising grinding dispersed silica coagulate prepared by a precipitation method or a gel method, wherein the absorption coefficient of said ink absorptive layer measured by dynamic scanning liquid absorption meter is from 1.0 to 5.0 ml/[m²·(msec)^{1/2}].

### DETAILED DESCRIPTION OF THE INVENTION

An ink jet recording medium of this invention (hereinafter, also referred to as a recording medium) is provided with an ink absorptive layer on a support.

As a support utilized for an ink jet recording medium of this invention, utilized can be either a water-absorptive support or a water-non-absorptive support, however, a water-non-absorptive support is preferred with respect to no generation of wrinkles after printing, obtaining a high quality printing without differences of smoothness as well as forming a glossy surface.

A water-absorptive support is typically a paper support, in particular, primarily comprising natural pulp, however, may be a mixture of synthetic pulp and natural pulp. A water non-absorptive support includes a plastic resin film support, or a paper support the both surfaces of which are covered with plastic resin film. Plastic resin film supports include polyester film, polyvinylchloride film, polypropylene film, cellulose triacetate film, polystyrene film or film supports in which these films are accumulated. Either transparent or translucent one of these plastic resin films can be utilized. Specifically preferable support in this invention is a paper support the both surfaces of which are covered with a plastic film, and most preferable is a support the both surfaces of which are covered with polyolefin resin. In the following, a support the both surfaces of which are covered with polyolefin resin will be explained.

Paper utilized in a support is made from wood pulp as a primary raw material, appropriately incorporating synthetic pulp such as polypropylene or synthetic fibers such as nylon and polyester in addition to wood pulp. As wood pulp, utilized can be any of LBKP, LBSP, NBKP, NBSP, LDP, NDP, LUKP and NUKP (L is an abbreviation for hard wood, N for soft wood, BK for sulfate breach, BS for sulfite breach and P for pulp), however, preferably more of LBKP, NBSP, LBSP, NDP or LDP which is rich in a short fiber component. Herein, the ratio of LBSP and/or LDP is preferably from 10 to 70%.

As the aforesaid pulp, chemical pulp (such as sulfate pulp and sulfite pulp) with minimal impurities is preferably utilized, and pulp of which whiteness has been improved by a breach treatment is also useful. Added in paper may be a sizing agent such as a higher fatty acid and an alkyl ketene dimmer, a white pigment such as calcium carbonate, talk and titanium oxide, a paper strength enhancing agent such as starch, polyacrylamide and polyvinyl alcohol, a fluorescent whitening agent, a water retaining agent such as polyethylene glycols, a dispersant, and a softening agent such as quaternary ammonium.

A drainage of pulp utilized in paper making is preferably from 200 to 500 ml based on the definition of CSF, and a fiber length after beating is preferably from 30 tp 70% as the sum of a 24 mesh residue and a 42 mesh residue based on the definition of JIS-P-8207. Wherein, a 4 mesh residue is preferably not more than 20%. A basis weight of paper is preferably from 50 to 250 g and specifically preferably from 70 to 200 g. A thickness of paper is preferably from 50 to 210 μm. Paper may be subjected to a calendar treatment during or after paper making to be provided with a high smoothness. A density of paper is generally from 0.7 to 1.2 g/m² (JIS-P-8118). Further, a stiffness of raw paper is preferably from 20 to 200 g based on the conditions defined in JIS-P-8143.

A surface sizing agent may be coated on the surface of paper, and sizing agents, similar to those can be added in the aforesaid raw paper, can be utilized as the surface sizing agent. A pH of paper is preferably 5 to 9 when being measured according to a hot water extraction method defined in JIS-P-8113.

Next, polyolefin resin which covers the both surfaces of paper is explained. Polyolefin resin utilized for this purpose includes such as polyethylene (PE), polypropylene (PP) and polyisobutylene, preferably polyolefins such as copolymers comprising polypropylene as a primary component and specifically preferably polyethylene.

In the following, specifically preferable polyethylene will be explained. Polyethylene covering the front and back surfaces of paper is primarily law density polyethylene (LDPE) and/or high density polyethylene (HDPE), however, other polyethylene such as LLDPE (linear law density polyethylene) and PP can be partly utilized. In particular, as a polyethylene layer of the coating layer side are preferably those opacity and whiteness of which having been improved by addition of titanium oxide of a rutile or anatase type therein. A content of titanium oxide is approximately from 1 to 20% and preferably from 2 to 15% based on polyethylene. A pigment or a fluorescent whitening agent, having high heat resistance, can be added in the polyolefin layer to adjust the white background.

Coloring pigments include such as ultramarine, prussian blue, cobalt blue, Phthalocyanine Blue, manganese blue, cerulian, tungsten blue, molybdenum blue and Anthraquinone Blue. Fluorescent whitening agents include such as dialkylamino coumarin, bisdimethylaminostilbene, bismethylaminostilbene, 4-alkoxy-1,8-narhthalene dicarboxylic acid-N-alkylimide, bisbenzoxazolyl ethylene and dialkylstilbene.

A using amount of polyethylene on the front and back sides of paper is selected so as to optimize the curl under low humidity and high humidity after an ink absorptive layer and a back-coating layer are provided, and the thickness of polyethylene layer is generally in a range of 15 to 40 μm on the ink absorptive layer side and in a range of 10 to 30 μm on the back-coat layer side. The ratio of polyethylene of the front to back side is preferably set to adjust the curl which varies depending on such as the type and thickness of an ink absorptive layer and the thickness of the center stock, and generally from 3/1 to 1/3 based on the thickness of polyethylene. Further, a paper support covered with the aforesaid PE is preferably provided with the characteristics of following (1) to (7).

(1) The tensile strength is preferably from 2 to 30 kg in the longitudinal direction and from 1 to 20 kg in the lateral direction, based on strength defined by JIS-P-8113.

(2) The tear strength is preferably from 10 to 300 g in the longitudinal direction and from 20 to 400 g in the lateral direction, based on strength defined by JIS-P-8116.

(3) The compressive modulus of elasticity is preferably not less than 9.8×10⁷ Pa.

(4) The opacity is preferably not less than 50% and specifically preferably from 85 to 98% when being measured by means of a method defined by JIS-P-8138.

(5) The whiteness based on L*, a*, b* defined by JIS-Z-8729 is preferably as follows:
L* is from 80 to 95,
a* is from −3 to +5, and
b* is from −6 to +2.

(6) The Clark stiffness is preferably from 20 to 400 cm³/100 based on Clark stiffness in the transport direction of a recording medium.

(7) The water content in raw paper is preferably from 4 to 10% based on the center stock.

Next, an ink absorptive layer will be explained.

A recording medium of this invention is provided with at least one ink absorptive layer, wherein said ink absorptive layer contains silica fine particles comprising ground dispersed silica coagulate prepared by a precipitation method or a gel method and has an absorption coefficient of 1.0 to 5.0 ml/[m²·(msec)^{1/2}], measured by a dynamic scanning liquid absorption meter.

As a result of extensive studies of the inventors, it has been proved that ink absorbability and image quality are simultaneously improved by controlling the absorption coefficient in such a range. The absorption coefficient is more preferably in the aforesaid range and not less than 1.5 ml/[m²·(msec)^{1/2}]]. The absorption coefficient measurement by a dynamic scanning liquid-absorption meter of said recording medium of this invention is performed by an apparatus and a method described in literature “Development and Application of Dynamic Scanning Liquid Absorption Meter” (by Kuga et al., Journal of Paper and Pulp Technologies 48(5), p 88 (1994)), and the tangent of the linear portion approximated from the obtained measurement plot is designated as an absorption coefficient defined by J. TAPPI's Paper and Pulp Testing Method No. 51-87 “Liquid Absorbability Testing Method for Paper and Pulp (Blister Method)”. It is meant that the larger is the absorption coefficient, the faster permeates ink into a recording sheet.

A liquid utilized in said test method is water, may be colored by dissolving a very small amount of a dye in water and, for example, water containing a dye of not more than 0.1% is regarded as water. The aforesaid dynamic scanning liquid absorption meter is an apparatus to perform measurement by means of a method in which a liquid is transferred onto a recording medium fixed on a horizontal turn table rotating at a constant speed, through a slit having a certain width and length and being brought in contact therewith, and the transferring amount of a liquid versus time can be measured to accurately determine an water absorption amount in a very short period. In a dynamic scanning liquid absorption meter, a liquid absorption speed is directly read from the shift of a meniscus in a capillary, a sample being cut into a disc shape on which a liquid absorption head is spirally scanned, and measurement is performed with respect to a necessary number of points in one sheet of the sample by automatically varying the scanning speed according to a predetermined pattern. In this way, the measurement is automated. A liquid supply head is connected to the capillary via a Teflon (R) tube, and the position of a meniscus in the capillary is automatically read out by use of an optical sensor. For example, Automatic Scanning Liquid Absorption Meter KM 500win, produced by Kumagai Riki-Kogyo Co., Ltd., can be utilized for the measurement.

A recording medium, of which ink absorbability is controlled as described above, can be prepared by controlling such as constituent materials, types of additives or the amount thereof in the ink absorptive layer described below and/or by over-coating various types of additives on the surface after ink absorptive layer is formed.

A recording medium of this invention is provided with at least one ink absorptive layer, however, may be provided with two or more ink absorptive layers having different physical properties or constituent materials. For example, utilized may be an ink absorptive layer constituted by multiple layers, which are comprised of an ink absorptive layer, being controlled to have a desired absorption coefficient of ink, as an upper layer, and an ink absorptive layer, being controlled to have a large ink absorption capacity as an under layer.

Further, an ink absorptive layer may be provided only on one surface of a support, however, also on the both surfaces. In the latter case, the ink absorptive layers provided on the both surfaces may be either the same or different. An ink absorptive layer is briefly classified into a swelling type ink absorptive layer and a void type ink absorptive layer, and an either type can be utilized in this invention. Further, possible is a combination of a swelling type ink absorptive layer and a void type ink absorptive layer. For example, also utilized may be a layer constitution in which a swelling type ink absorptive layer is provided on the side nearer from the support and a void type ink absorptive layer on the remote side from the support, or the opposite layer constitution. In addition to this, ink absorptive layers of the front and back sides may be same type or different types in the case of a recording medium in which the both surfaces of the support are provided with an ink absorptive layer. A void type ink absorptive layer is specifically preferred in this invention.

A void type ink absorptive layer is preferably a porous film having a void layer comprising an inorganic or organic fine particles and a small amount of a hydrophilic polymer, and, in this invention, utilized are silica fine particles comprising grinding dispersed silica aggregate which has been manufactured by means of a precipitation method or a gel method, as described above, because an ink absorptive layer having an excellent ink absorbability can be formed.

In the precipitation method referred in this invention, as is well known, firstly sodium silicate and sulfuric acid are mixed. At this time, the mixing conditions (such as temperature, silica concentration and time duration) are controlled to make silica precipitate in a solution. The precipitated silica is sedimented and ripened, followed by being filtered, washed with water, dried, ground and classified to prepare synthetic amorphous silica.

Further, in a gelation method referred in this invention, as is well known, sodium silicate and sulfuric acid are firstly mixed in a moment to grow a hydrogel from a hydrosol. In the method, after the grown hydrogel is washed with water, it is heat treated to control the surface area, and the resulting hydrogel is dried and classified to prepare synthetic amorphous silica.

Silica fine particles of this invention, as described above, are characterized by utilizing silica fine particles comprising the aforesaid silica coagulate having been grinding dispersed, and grinding dispersion means to subdivide silica coagulate of approximately from 1.0 to 50 μm in a dispersing medium by a mechanical means. The mean particle diameter before grinding dispersion is preferably from 1.0 to 10.0 μm. As these silica, available on the market are such as Fineseal and Tokuseal, manufactured by Tokuyama Corp., and Nipgel and Nipsil, manufactured by Nippon Silica Indusry Co., Ltd.

A grinding dispersion method preferably provided with a preliminary dispersion process and a main dispersion process, and utilized grinding dispersion methods include such as a high speed stirring homogenizer, an ultrasonic homogenizer, a roller mill type, a kneader mill type, a pin mixer type, a high-pressure homogenizer and a wet medium type grinder (such as a sand mill and a ball mill).

The concentration of silica at the time of grinding dispersion is preferably from 20 to 50 weight % and more preferably from 25 to 40 weight %, in consideration of productivity and easy handling. Grinding dispersed silica fine particles may be subjected to a process to control coarse particles, the methods include such as a centrifugal method and a filtering method. The centrifugal method can employ, for example, Micro-Cut, produced by Kuretech Co., Ltd. The filtering method can employ, for example, Profile, manufactured by Nippon Pole Co., Ltd. or TCPD, manufactured by Advantech Toyo Co., Ltd.

The aforesaid dispersion medium is not specifically limited, however, is preferably a water-based medium, said water-based medium preferably containing a cationic polymer and a hardener in addition to water.

The aforesaid cationic polymer includes, for example, cationic polymers described in JP-A No. 2000-47454.

The aforesaid hardener is preferably a compound provided with a group being reactive with the aforesaid hydrophilic polymer, or a compound which promotes a reaction between different groups of said hydrophilic polymer, and is appropriately utilized by being selected according to a type of the hydrophilic polymer. Specific examples of hardeners include, for example, epoxy type hardeners (such as diglicidyl ethylether, ethyleneglycol diglicidyl ether, 1,4-butanediol diglicidyl ether, 1,6-diglicidyl cyclohexane, N,N-diglicidyl-4-glicidyl oxyaniline, solbitol polyglicidyl ether and glicerol polyglicidyl ether), aldehyde type hardeners (such as formaldehyde and glyoxal), active halogen type hardeners (such as 2,4-dichloro-6-hydroxy-1,3,5-triazole), active vinyl type hardeners (such as 1,3,5-trisaryloyl-hexahydro-s-triazine and bisvinylsulfonyl methylether), isocyanate type hardeners (such as tolylene diisocyanate and diphenylmethane diisocyanate), boric acid, borate, borax and alum.

Further, hydrophilic polymers and various types of additives may be added in advance in a dispersion medium or in a dispersion solution in which inorganic fine particles having been dispersed, and, appropriately utilized can be, for example, nonionic or cationic various types of surfactants, defoarming agents, nonionic hydrophilic polymers (such as polyvinyl alcohol, polyvinyl pyrrolidone, polyethyleneoxide, polyacrylamide, various types of sugars, gelatin and pullulane), nonionic or cationic latex dispersions, water-miscible organic solvents (such as ethyl acetate, methanol, ethanol, i-propanol, propanol and acetone), inorganic salts, and pH adjusting agents. A recording medium of this invention can be prepared by coating a coating solution comprising these constituent materials on the aforesaid support.

The mean particle diameter of grinding dispersed fine particles is preferably from 100 to 350 nm. The ink absorbability can be improved when it is not less than 100 nm, and excellent glossiness can be obtained when it is not more than 350 nm. Further, in this invention, it is preferred that the relationship between the mean particle diameter of grinding dispersed silica fine particles, y (nm), and the number of particles which diameter is not less than 10 μm contained in 1 g of silica fine particles, x (particles), satisfies following equation (1).
150<y+17·ln(x)<500 Equation (1)

Excellent ink absorbability can be obtained when the value of y+17·ln(x) exceeds 150, and excellent glossiness can be obtained when it is less than 500. Herein, the mean particle diameter of silica fine particles can be determined by use of, for example, Zetasizer 1000HS, produced by Malvern Instruments. Further, the number of particles which diameter is not less than 10 μm in 1 g of silica fine particles can be determined by use of, for example, HIAC/ROYCO Model 18000A Particle Counter, produced by Pacific Scientific Corp. Measurement of the number of particles which diameter is not less than 10 μm in 1 g of silica fine particles is specifically performed as follows: a solution of 0.25 weight %, based on the concentration of silica fine particles, is prepared by dilution of a silica fine particle dispersion, and the particle number of not less than 10 μm in 10 ml of the 0.25 weight % solution by use of the aforesaid measurement device resulting in determination of the converted particle number of not less than 10 μm in 1 g of silica fine particles. The measurement is performed over a range of 2 to 100 μm.

An ink absorptive layer of this invention may contain other inorganic fine particles together with the inorganic fine particles explained above, and examples of such inorganic fine particles include white inorganic pigments such as light calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic amorphous silica, colloidal silica, alumina, colloidal alumina, seudo boehmite, aluminum hydroxide, lithopone, zeolite and magnesium hydroxide. Inorganic fine particles can be utilized either as primary particles as they are or in a state of forming aggregated secondary particles.

A hydrophilic polymer utilized in an ink absorptive layer of this invention is preferably polyvinyl alcohol (PVA). Polyvinyl alcohol utilized in this invention includes modified polyvinyl alcohol such as polyvinyl alcohol the ends of which are cation modified and anion modified polyvinyl alcohol provided with an anionic group, other than ordinary polyvinyl alcohol which is obtained by hydrolysis of polyvinyl acetate. The average polymerization degree of polyvinyl alcohol obtained by hydrolysis of polyvinyl acetate is preferably not less than 300 and specifically preferably from 1000 to 5000. The saponification degree is preferably from 70 to 100% and specifically preferably from 80 to 99.5%. The weight ratio of a hydrophilic polymer to the aforesaid inorganic or organic fine particles is generally from 1/10 to 1/3 and specifically preferably from 1/8 to 1/5.

In the case that ink absorptive layer of this invention contains such as polyvinyl alcohol as a hydrophilic polymer, a hardener is preferably added to improve a film forming property and to enhance water resistance or strength of the film. The hardeners are generally compounds provided with a group being reactive with the aforesaid hydrophilic polymer or compounds to promote a reaction between different groups of the hydrophilic polymer, and utilized by being appropriately selected depending on the types of hydrophilic polymers. Specific examples of the hardener include the aforesaid compounds. In the case of utilizing polyvinyl alcohol as a hydrophilic polymer, preferably utilized is a hardener selected from boric acid, borate and epoxy type hardeners. The using amount of the aforesaid hardener varies depending on a type of a hydrophilic polymer, a type of a hardener, a type and a ratio against hydrophilic polymer of silica fine particles, however, is generally from 5 to 500 mg and preferably from 10 to 300 mg, per g of the hydrophilic polymer. Further, plural types of hardeners can be utilized in combination.

Various types of additives other than those described above can be added in an ink absorptive layer of a recording medium. Among them, preferable are cation mordants with respect to improving water resistance and moisture resistance after printing. As cation mordants, utilized are polymer mordants provided with a primary to tertiary amino group or a quaternary ammonium base, however, preferable is a mordant having a quaternary ammonium base because color change or deterioration of light fastness on aging is small and mordant ability is sufficiently high. Preferable polymer mordants can be prepared as homopolymers of the aforesaid monomer provided with a quaternary ammonium base, or copolymers or condensed polymers of said monomer with other monomers. Specific examples of cation mordants are described, for example, in “Techniques and Materials of Ink jet Printer”, p. 268 (C. M. C Co., Ltd.). In addition to this, also incorporated can be commonly known additives of various types such as ultraviolet absorbers described in such as JP-A Nos. 57-74193, 57-87988 and 62-261476, anti-fading agents described in such as JP-A Nos. 57-74192, 57-87989, 60-72785, 61-146591, 1-95091 and 3-13376, anion, cation or nonion surfactants, fluorescent whitening agents described in such as JP-A Nos. 59-42993, 59-52689, 62-280069, 61-242871 and 4-219266, defoarming agents, wetting agents such as ethylneglycol, antiseptic agents, viscosity increasing agents and anti-static agents.

The glossiness of the ink absorptive layer side of a recording medium of this invention is preferably from 40 to 80% based on the 75 degree mirror surface glossiness measurement according to JIS-Z-8741. The smaller is this glossiness, the more liable to decrease is the visibility of a recorded image. Herein, the glossiness, in this invention, is preferably in the above range when measured at 75 degree, however, is generally a smaller value when measured at a smaller degree such as 60 degree or 45 degree.

A recording medium of this invention can be prepared by coating a coating solution, which forms an ink absorptive layer, onto the aforesaid support. Herein, the aforesaid inorganic fine particles, which are preferably utilized in an ink absorptive layer, are preferably utilized as a coating solution after having been sufficiently dispersed in a dispersion medium.

At the time of coating an ink absorptive layer, a support is preferably provided with a corona discharge treatment or an under-coat layer for the purpose of increasing adhesion strength between the surface of the support and the coating layer. An under-coat layer is provided by utilizing a hydrophilic polymer such as gelatin or polyvinyl alcohol appropriately incorporating a hardener. The thickness of the under-coat layer is preferably from 0.01 to 1.0 μm.

In the case of an ink jet recording medium of this invention is applied for recording on only one of the surfaces, various types of back-coat layers can be provided on the surface opposite to an ink absorptive layer side to further improve anti-curling, prevention of adhesion or ink transfer at the recording medium being accumulated immediately after printing. The constitution of the back-coat layer varies depending on the type and thickness of the support and the constitution and thickness of the surface side layers, however, generally utilized is a hydrophilic binder or a hydrophobic binder.

The thickness of a back-coat layer is generally in a range of 0.1 to 10.0 μm. Further, the surface of a back-coat layer can be roughened to prevent adhesion with other recording materials, to improve writability as well as to improve transport properties in an ink jet recording apparatus. For this purpose, preferably utilized are organic or inorganic fine particles having a particle diameter of 0.5-20.0 μm. These back-coat layers may be provided in advance or after coating of an ink absorptive layer of the opposite side.

As a coating method of an ink absorptive layer, preferably utilized is a roll coating method, a rod-bar coating method, an air-knife coating method, a spray coating method, a curtain coating method or an extrusion coating method in which a hopper described in U.S. Pat. No. 2,681,294 is employed. In the case that polyolefin resin coated paper is used as a support, the drying is performed preferably in a range of approximately from 0 to 80° C. Polyolefin resin may be softened to make the transportation difficult or generate unevenness of gloss of the recording layer surface when the temperature exceeds 80° C. Preferable drying temperature is 60° C.

After drying, over-coated may be a solution containing various types of additives commonly known, such as the aforesaid surfactants, ultraviolet absorbents, anti-fading agents, hardeners, cation mordants, defoarming agents, fluorescent whitening agents, antiseptic agents, and viscosity increasing agents. It is also possible to control the surface wettability by over-coating.

Surfactants include anion surfactants, cation surfactants, amphoteric surfactants and nonion surfactants, however, it is preferable to utilize an anion surfactant or a cation surfactant, each alone or in combination thereof.

Inorganic particles and/or organic particles also can be added in an over-coat coating solution. Inorganic particles include white inorganic pigments such as light or heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic amorphous silica, colloidal silica, alumina, colloidal alumina, seudo boehmite, aluminum hydroxide, lithopone, zeolite and magnesium hydroxide. Further, organic particles include such as acryl resin, urea resin, melamine resin, phenol resin and styrene resin.

A method to provide an over-coat layer on an ink absorptive layer is not specifically limited and utilized can be conventionally known coaters such as a bar coater, an air-knife coater, a blade coater and a curtain coater, or a printing machine. Further, the coating amount of an over-coat layer is not required to be increased unnecessarily as far as it satisfies desired capabilities, and is preferably in a range of 0.2 to 5.0 g/m².

Next, an ink jet recording method of this invention will be explained.

A method to perform ink jet recording on the aforesaid ink jet recording medium by use of water-based ink is not specifically limited, and printed letters or images can be obtained employing an ink jet printer of a piezo-mode or a thermal-mode. The details of the recording methods are described, for example, in “Trend of Ink jet Technologies” (Nippon Scientific Information Corp.).

The utilized water-based ink is not specifically limited, and preferably utilized is one, which contains at least one type among oil-based dyes, dispersion dyes, direct dyes, acid dyes, water-based dyes and basic dyes, as a colorant. These dyes described above are listed in such as “Dye Note, 21st edition” (Shikisen-Sha). Further, preferably utilized is water-based ink which contains conventionally known various types of additives, for example, a wetting agent such as polyhydric alcohols, a dispersant, a defoarming agent such as a silicone type, an anti-mold agent such as a chloromethylphenol type and/or a chelating agent such as EDTA (ethylenediamine tetraacetic acid), and auxiliary agents like an oxygen absorbing agent such as a sulfite salt.

An ink jet head which can be utilized in a recording method of this invention may be either of an on-demand mode or a continuous mode. Further, an ink ejection mode includes such as an electro-mechanical conversion mode (such as a single cavity type, a double cavity type, a vendor type, a piston type, a share mode type and a shared-wall type), an electro-thermal conversion mode (such as a thermal ink jet type and a bubble jet (R) type), an electrostatic suction mode (such as an electric field control type and a slit jet type) and a discharge mode (such as a spark jet type) as specific examples, and any mode may be employed.

### EXAMPLES

In the following, this invention will be specifically explained with reference to the examples, however, the embodiment of this invention is not limited thereto.

### Preparation of Support

Low density polyethylene having a density of 0.92 was coated on the back side of photographic raw paper having a water content of 6.5% and a basis weight of 170 g/m² by means of a fusing extrusion coating method so as to make a thickness of 30 μm. Next, low density polyethylene, having a density of 0.92 and containing 5.5% of anatase type titanium oxide, was coated on the front side by means of a fusing extrusion coating method so as to make a thickness of 35 μm. In this way, a support both surfaces of which were covered with polyethylene was prepared.

After corona discharge was applied on the front side, a gelatin under-coat was coated so as to make a thickness of 0.3 g/m², and after corona discharge was also applied on the back side, a latex layer was coated so as to make a thickness of 2.0 g/m².

### Preparation of Titanium Oxide Dispersion 1

Titanium oxide, having a mean particle diameter of approximately 0.25 μm, of 20 kg (W-10, manufactured by Ishihara Sangyo Kaisha, Ltd.) was added in 90 L of an aqueous solution containing 150 g of sodium tripolyphosphate having a pH of 7.5, 500 g of polyvinyl alcohol (PVA 235, manufactured by Kuraray Co., Ltd.), 150 g of cationic polymer (P-1) and 10 g of defoarming agent SN 381, manufactured by Sunnobuco Co., Ltd., and after the system was dispersed by a high-pressure homogenizer (produced by Sanwa Industrial Co., Ltd.), the total volume was made up to 100 L resulting in preparation of titanium oxide dispersion 1.
Cationic polymer (P-1)

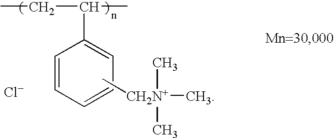

### Preparation of Fluorescent Whitening Agent Dispersion 1

Oil-soluble fluorescent whitening agent UVITEX-OB, manufactured by Ciba-Geigy Corp., of 400 g was dissolved with heating in 9000 g of diisodecyl phthalate and 12 L of ethyl acetate; the resulting solution was added to 65 L of an aqueous solution, containing 3500 g of acid-processed gelatin, 0.8 kg of cationic polymer (P-1) and 6 L of 50% saponin aqueous solution, to be mixed and was emulsifying dispersed with a high pressure homogenizer, produced by Sanwa Kogyo Co., Ltd.; then the total volume was made up to 100 L after ethyl acetate was eliminated under reduced pressure resulting in preparation of fluorescent whitening agent dispersion 1.

### Preparation of Silica Dispersion 1

As a water-based medium (hereinafter, referred to as solution A), the following composition were mixed and dissolved.

| | | |
|---|---|---|
| Water | 80 | L |
| Boric acid | 0.27 | kg |
| Borax | 0.23 | kg |
| 5% nitric acid | 0.4 | L |
| Ethanol | 1.8 | L |
| Cationic Polymer (P-1) (25 weight % aqueous solution) | 6 | L |

As silica, prepared was 32 kg of precipitation method silica (product name: T-32, a mean particle diameter of 1.5 μm, manufactured by Tokuyama Corp., hereinafter being referred to as T-32), and was dispersed as follows to prepare dispersion 1. Solution A at 1.56 kg/min and T-32 at 0.44 kg/min were supplied into Flow Jet Mixer 300 Type (a pin mixer type, produced by Hunken Pawtex Co., Ltd., hereinafter, referred to as FJM) as homogenizer 1. Next, the resulting dispersion was supplied to Fine Flow Mill FM-25 (a continuous mode high-speed mixing type homogeniszer, produced by Taiheiyo Kiko Co., Ltd., hereinafter, referred to as FM) as homogenizer 2. Further, the dispersion flowing out from homogenizer 2 was supplied to LMK-4 (a continuous and wet mode media type homogenizer, produced by Ashizawa Co., Ltd., hereinafter, referred to as LMK) as homogenizer 3 at 2.0 kg/min by use of a mono-pump. The conditions of FMJ were a circumferential speed of 25 m/sec and a retention time of 20 sec.; those of FM were a circumferential speed of 25 m/sec and a retention time of 0.15 sec.; and those of LMK were a zirconium beads having a diameter of 0.5 mm, a retention time of 5 min. and a rotational circumferential speed of the rotor of 11 m/sec. Thereafter, the dispersion flowing out from LMK was subjected to a filtering treatment. Profile, manufactured by Nippon Pole Co., Ltd., was utilized as a filter. The mean particle diameter and the number of particles of not less than 10 μm were measured to determine the value represented by equation (1) described above to be 390. The mean particle diameter at this time was 200 nm.

### Preparation of Silica Dispersion 2

The dispersion was prepared in a similar manner to silica dispersion 1, except that two times of passes through LMK were applied. The value of equation (1) described above was 220 and the mean particle diameter was 150 nm.

### Preparation of Silica Dispersion 3

The dispersion was prepared in a similar manner to silica dispersion 1, except that the rotational circumferential speed of the rotor of LMK was set to 7 m/sec. The value of equation (1) described above was 470 and the mean particle diameter was 280 nm.

### Preparation of Silica Dispersion 4

The dispersion was prepared in a similar manner to silica dispersion 1, except that a filter treatment was not performed. The value of equation (1) described above was 530 and the mean particle diameter was 220 nm.

### Preparation of Silica Dispersion 5

The dispersion was prepared in a similar manner to silica dispersion 1, except that the rotational circumferential speed of the rotor of LMK was set to 15 m/sec. The value of equation (1) described above was 360 and the mean particle diameter was 170 nm.

### Preparation of Silica Dispersion 6

The dispersion was prepared in a similar manner to silica dispersion 1, except that LMK was replaced by a high-pressure homogenizer, the dispersion was performed once at a pressure of 350 kg/cm2 and a filter treatment was not performed. The value of equation (1) described above was 750 and the mean particle diameter was 380 nm.

### Preparation of Silica Dispersion 7

The dispersion was prepared in a similar manner to silica dispersion 1, except that silica was changed to gel method silica (product name: AZ-204, manufactured by Nippon Silica Co., Ltd., having a mean secondary particle diameter of 1.3 μm). The value of equation (1) described above was 430 and the mean particle diameter was 220 nm.

### Preparation of Silica Dispersion 8

In a similar recipe to silica dispersion 1, grinding dispersion was not performed in the preparation of silica dispersion but dispersion was performed by only a homo-mixer. The value of equation (1) described above was 1970 and the mean particle diameter was 1.5 μm.

### Preparation of Silica Dispersion 9

The dispersion was prepared in a similar manner to silica dispersion 1, except that silica was replaced by air phase method silica (product name: A-300, manufactured by Nippon Aerosil Co., Ltd.). The value of equation (1) described above was 260 and the mean particle diameter was 170 nm.

[Preparation of Ink jet Recording Medium 1]

### Preparation of Coating Solution

Coating solutions of the first, second and third layers were prepared according to the following procedure.

The first layer coating solution:

The following additives were successively added while stirring at 40° C. into 560 ml of adjusted dispersion 5 having been adjusted to make a silica weight concentration of silica dispersion 1 to be 10%.

| | |
|---|---|
| 10% aqueous solution of polyvinyl alcohol (PVA203, | 0.6 ml |
| manufactured by Kuraray Co., Ltd.) | |
| 5% aqueous solution of polyvinyl alcohol (PVA235, | 150 ml |
| manufactured by Kuraray Co., Ltd.) | |
| 5% aqueous solution of polyvinyl alcohol (PVA245, | 100 ml |
| manufactured by Kuraray Co., Ltd.) | |
| Fluorescent whitening agent dispersion 1 | 32 ml |
| Titanium oxide dispersion 1 | 30 ml |
| Latex emulsion (AE-803, manufactured by Daiichi Kogyo | 21 ml |
| Co., Ltd.) | |

The total volume is made up to 1000 ml with pure water.

The second layer coating solution:

The following additives were successively added while stirring at 40° C. into 630 ml of adjusted dispersion 6 having been adjusted to make a silica weight concentration of silica dispersion 1 to be 10%.

| | |
|---|---|
| 10% aqueous solution of polyvinyl alcohol (PVA203, | 0.6 ml |
| manufactured by Kuraray Co., Ltd.) | |
| 5% aqueous solution of polyvinyl alcohol (PVA235, | 150 ml |
| manufactured by Kuraray Co., Ltd.) | |
| 5% aqueous solution of polyvinyl alcohol (PVA245, | 100 ml |
| manufactured by Kuraray Co., Ltd.) | |
| Fluorescent whitening agent dispersion 1 | 50 ml |

The total volume is made up to 1000 ml with pure water.

The third layer coating solution:

The following additives were successively added while stirring at 40° C. into 640 ml of adjusted dispersion 6 having been adjusted to make a silica weight concentration of silica dispersion 1 to be 10%.

| | |
|---|---|
| 10% aqueous solution of polyvinyl alcohol (PVA203, | 0.6 ml |
| manufactured by Kuraray Co., Ltd.) | |
| 5% aqueous solution of polyvinyl alcohol (PVA235, | 150 ml |
| manufactured by Kuraray Co., Ltd.) | |
| 5% aqueous solution of polyvinyl alcohol (PVA245, | 100 ml |
| manufactured by Kuraray Co., Ltd.) | |
| Silicone dispersion (BY-22-839, manufactured by Toray | 3.5 ml |
| Dow-Corning Silicone Co., Ltd.) | |
| 50% aqueous solution of Saponin | 4 ml |
| 5% aqueous solution of fluoride type nonionic surfactant | 2 ml |

The total volume is made up to 1000 ml with pure water.

### Coating

The coating solutions prepared above were simultaneously coated on the front side of a support the both surfaces of which covered with polyethylene so as to make the first layer (40 μm), the second layer (110 μm) and the third layer (30 μm) in this order. The each figure in the parenthesis indicates each wet layer thickness. Each coating solution was simultaneously coated at 40° C. by use of a three-layer mode curtain coater, after having been cooled in a zone cooled at 8° C. for 20 seconds, the coated medium was dried successively with air of 20 to 30° C. for 60 seconds, with air of 45° C. for 60 seconds and with air of 50° C. for 60 seconds (the film temperature at a constant rate drying range was 8 to 25° C. and that at a falling rate drying range increased gradually), followed by being rehumidified at 23° C. and a relative humidity of 40 to 60% resulting in preparation of ink jet recording medium 1.

[Preparation of Ink Jet Recording Media 2-11]

Ink jet recording media 2-9 were prepared in a similar manner to above-described ink jet recording medium 1, except that silica dispersion 1 was replaced by silica dispersions 2-9. Next, an isocyanate type cross-linking agent (mixture of Coronate 3041, manufactured by Nippon Polyurethan Industrial Co., Ltd. and Sumijule N3300, manufactured by Sumitomo-Beyer Co., Ltd. at a weight ratio of 2/8) dissolved in ethyl acetate was over-coated on ink jet recording medium 1 so as to make 2.0 g/m², resulting in preparation of ink jet recording medium 10. Further, ink jet recording media 11 was prepared in a similar manner to above-described ink jet recording medium 1, except that the first and second layers were replaced by silica dispersion 7.

With respect to obtained ink jet recording media, the silica type, dispersion results, absorption coefficient and 75 degree mirror surface glossiness are shown in Table 1. The mean particle diameter is a value measured by Zetasizer 1000HS, produced by Marubarn Co., Ltd. The value of equation (1) was calculated by y+17·ln(x). Wherein, y (nm) is a mean particle diameter of grinding dispersed silica fine particles, and x (a particle number) is a number of particles which diameter is not less than 10 μm in 1 g of silica fine particles. The particle number of not less than 10 μm was measured by HIAC/ROYCO Model A Particle Counter, produced by Pacific Scientific Corp. Measurement of the particle number having a diameter of not less than 10 μm was performed by diluting a silica dispersion to prepare a silica fine particle solution having a weight concentration of 0.25%, measuring the particle number of not less than 10 μm in 10 ml of a 0.25% solution by use of the aforesaid measurement device, and said particle number being converted into a particle number of not less than 10 μm in 1 g of silica fine particles. The measurement range was 2-100 μm. The absorption coefficient of a recording medium was determined as follows: after a recording medium was kept under a condition of 25° C. and 50% RH for 24 hours, an absorption curve was measured employing 0.05% aqueous solution C.I. Acid Red 52 by use of Automatic Scanning Liquid Absorption Meter KM 500win, produced by Kumagai Riki-Kogyo Co., Ltd. At the absorption curve, plotted was a transfer amount (ml/m2) vs. a square root of a contact time ((msec)^{1/2}) to form a straight line having a certain tangent, which was calculated as a absorption coefficient. The glossiness was measured at an incidence angle of 75° and an acceptance angle of 75° by use of VGS-1001DP type Glossiness Meter, produced by Nippon Denshoku Industrial Co., Ltd.

TABLE 1

| | | | Silica | | | | |
|---|---|---|---|---|---|---|---|
| | | | particle | | | | |
| | | | diameter | Value | | | |
| | | | after | of | Absorption | | |
| Recording | | Grinding | dispersion | equation | coefficient | Glossiness | |
| medium | Silica type | dispersion | (nm) | (1) | (ml/[m² · (ms)^{1/2}]) | (%) | Remarks |
| 1 | Precipitation | Yes | 200 | 390 | 2.4 | 67 | Invention |
| | method | | | | | | |
| 2 | Precipitation | Yes | 150 | 220 | 1.2 | 70 | Invention |
| | method | | | | | | |
| 3 | Precipitation | Yes | 280 | 470 | 4.8 | 56 | Invention |
| | method | | | | | | |
| 4 | Precipitation | Yes | 220 | 530 | 3.9 | 55 | Invention |
| | method | | | | | | |
| 5 | Precipitation | Yes | 170 | 360 | 1.8 | 69 | Invention |
| | method | | | | | | |
| 6 | Precipitation | Yes | 380 | 750 | 5.3 | 48 | Comparison |
| | method | | | | | | |
| 7 | Gel method | Yes | 220 | 430 | 2.7 | 66 | Invention |
| 8 | Precipitation | No | 1500 | 1970 | 6.6 | 24 | Comparison |
| | method | | | | | | |
| 9 | Gas phase | Yes | 170 | 260 | 0.8 | 69 | Comparison |
| | method | | | | | | |
| 10 | Precipitation | Yes | 200 | 390 | 2.6 | 67 | Invention |
| | methodyes | | | | | | |
| 11 | Combination | Yes | — | — | 2.6 | 67 | Invention |
| | of two | | | | | | |
| | methods | | | | | | |

[Evaluation of Ink Jet Image]

### Evaluation of Resolution

Lines of black, cyan, magenta and yellow having a width of 100 μm were printed on recording media 1-11 prepared above by use of Color Ink jet Printer PM800C (Seiko Epson Corp.), which was magnified by 50 times by a microscope to be visually evaluated based on the following criteria. The results are shown in Table 2.

A: The dot shape is very sharp.

B: The dot shape is sharp.

C: The dot shape is partly getting out of shape, however, it is not a problem in practical use.

D: The dot shape is not-retained.

### Evaluation of Image Quality

A black letter image on a yellow solid background was printed on recording media 1-11 prepared above by use of Color Ink jet Printer PM800C (Seiko Epson Corp.), and each image was visually evaluated based on the following criteria. The results are shown in Table 2.

A: No bleeding of letters is observed.

B: Slight bleeding of letters is observed, however, it is not a problem in practical use.

C: Bleeding of letters is observed, and it is a problem in practical use.

D: Not an acceptable level at all.

### Evaluation of Coloring Property

A black solid image was printed on recording media 1-11 prepared above by use of Color Ink jet Printer PM800C (Seiko Epson Corp.), and the reflection density was measured by use of a densitometer (X-Rite 983, produced by X-Rite Co., Ltd.). The results are shown in Table 2.

TABLE 2

| Recording | | Image | Coloring | |
|---|---|---|---|---|
| medium | Resolution | quality | property | Remarks |
| 1 | B | A | 2.3 | Invention |
| 2 | B | A | 2.3 | Invention |
| 3 | A | B | 2.2 | Invention |
| 4 | A | B | 2.3 | Invention |
| 5 | B | A | 2.3 | Invention |
| 6 | B | B | 1.5 | Comparison |
| 7 | A | B | 2.3 | Invention |
| 8 | C | B | 1.2 | Comparison |
| 9 | B | C | 1.9 | Comparison |
| 10 | A | A | 2.2 | Invention |
| 11 | A | A | 2.2 | Invention |

As is clear from Table 2, it has been proved that those recorded by use of the ink jet recording media of this invention exhibits excellent ink absorbability, and excellent effects in all of resolution, image quality and a coloring property, compared to the comparisons.

1. An ink jet recording medium comprising:
a support; and
an ink absorptive layer provided thereon;
the ink absorptive layer containing silica fine particles, wherein an absorption coefficient of the ink absorptive layer measured by dynamic scanning liquid absorption meter is from 1.0 to 5.0 ml/[m²·(msec)^{1/2}].

2. The ink jet recording medium of claim 1, wherein the silica fine particles are made by grinding dispersed silica coagulate prepared by a precipitation method.

3. The ink jet recording medium of claim 1, wherein the silica fine particles are made by grinding dispersed silica coagulate prepared by a gel method.

4. The ink jet recording medium of claim 1, wherein the mean particle diameter of the silica fine particles is from 100 to 350 nm.

5. The ink jet recording medium of claim 4, wherein the silica fine particles are satisfying following equation (1), wherein y (nm) is the mean particle diameter of the silica fine particles, and x (a particle number) is a number of particles having their diameters are not less than 10 μm contained in 1 g of the silica fine particles.
150<y+17·ln(x)<500

6. The ink jet recording medium of in claim 5, wherein the ink absorptive layer contains silica fine particles being made by grinding dispersed silica coagulate prepared by both a gel method and a precipitation method.

7. The ink jet recording medium of in claim 2, wherein the grinding dispersion of silica coagulate is obtained by a treatment of a preliminary dispersion process and a main dispersion process thereafter.

8. The ink jet recording medium of claim 7, wherein the treatment of the main dispersion process is conducted by a wet mode media type grinding apparatus.
